(19) United States
(12) Patent Application Publication
(10) Pub. No.: US 2019/0314738 A1
(43) Pub. Date: Oct. 17, 2019

(54) TRAP ASSEMBLY AND SYSTEM FOR TRAPPING POLYMER VAPORS IN PROCESS OVEN VACUUM SYSTEMS

(71) Applicant: YIELD ENGINEERING SYSTEMS, INC., LIVERMORE, CA (US)

(72) Inventors: WILLIAM MOFFAT, SAN JOSE, CA (US); CRAIG WALTER MCCOY, SAN JOSE, CA (US)

(21) Appl. No.: 16/189,631

(22) Filed: Nov. 13, 2018

Related U.S. Application Data
(63) Continuation-in-part of application No. 15/812,753, filed on Nov. 14, 2017.
(60) Provisional application No. 62/421,671, filed on Nov. 14, 2016.

(51) Int. Cl. B01D 5/00

(52) U.S. Cl. CPC B01D 5/0045; F04B 37/14; B01D 5/009

(57) ABSTRACT

A trap system adapted to trap polyimide or other vapors exiting from a process chamber. The vapors are routed from the process chamber through a heated exit line at low pressure and then cooled, resulting in condensation at a selected location. The condensed vapors accumulate in a liquid trap. A method of condensing polymer vapors in vacuum exit lines of process chambers, where the flow which may have vaporized polymer vapor is cooled to enhance condensation at a chosen location. The liquid trap can be emptied and replaced, resulting in the removal of the condensed liquid. The chamber exit lines are protected from condensation build up.

### CROSS-REFERENCE TO RELATED APPLICATIONS

This application is a continuation-in-part of U.S. patent application Ser. No. 15/812,753 to Moffat et al., filed Nov. 14, 2017, which claims priority to U.S. Provisional Patent Application No. 62/421,671 to Moffat et al., filed Nov. 14, 2017, both of which are hereby incorporated by reference in their entirety.

### FIELD OF THE INVENTION

This invention relates to vacuum systems, namely a system for trapping condensation in a designated location outside of a process oven.

### BACKGROUND OF THE INVENTION

A continuing trend in semiconductor technology is the formation of integrated circuit (IC) chips having more and faster circuits thereon. Such ultralarge scale integration has resulted in a continued shrinkage of feature sizes with the result that a large number of devices are made available on a single chip. With a limited chip surface area, the interconnect density typically expands above the substrate in a multi-level arrangement and the devices have to be interconnected across these multiple levels. The interconnects must be electrically insulated from each other except where designed to make contact. Usually electrical insulation requires depositing dielectric films onto a surface, for example using a CVD or spinning-on process. The shrinkage in integrated circuit design rules has simultaneously reduced the wiring pitch. These have made the signal propagation delay in the interconnects an appreciable fraction of the total cycle time. The motivation to minimize signal delay has driven extensive studies to develop a low dielectric constant (low-k) material that can be used as an inter-level dielectric in integrated circuit (IC) manufacturing. The majority of low-k materials used in the ILD layer are based on thermally cured spin-on organic or inorganic polymers.

Polyimide is a polymer material often used in the production of semiconductor substrates such as silicon wafers. Polyimide is a desirable insulating material for semiconductor wafers because of its outstanding physical properties. Unfortunately, polyimide typically requires a long time to cure when conventional heating techniques are used. A cure cycle of several hours is typical and this often becomes the pacing step in semiconductor fabrication. In addition, there are other problems involved with curing polyimide resin with conventional heat. For example, when polyimide resin is cured in a conventional furnace, the outer surface of the resin typically cures faster than the center portions. This can cause various physical defects, such as the formation of voids, and can result in inferior mechanical properties such as reduced modulus, enhanced swelling, solvent uptake, and coefficient of thermal expansion.

A polyimide precursor may be applied to a substrate, and then dried to prepare for imidization of the polymer. A goal of the drying process is to remove the solvent from the polymer (which may be N-Methyl-2-pyrrolidone, NMP, for example), and it can also be important to remove oxygen during the drying process. In addition, further goals of the drying process are to minimize or eliminate any bubbles/voids in the polymer layer, to minimize discoloration to the layer that may be induced by heating, and to fully remove residual solvent from the precursor mix. Each of these items sought to be eliminated may interfere with subsequent process steps, or enhance the probability of failure of a device containing the polyimide layer.

Process ovens may be used to vacuum bake semiconductor substrates in support of various processes. A polyimide bake oven may be used for temperature imidization of polyimide layers, for example. Polymer vapors may be released during such processes, and these vapors would typically route through vacuum lines as part of their exit from the process chamber.

In some such processes, a polyimide is temperature imidized at 400-450 C. A typical solvent for the process may be NMP. During the temperature imidization the vaporized solvents may carry vaporized polymer downstream, resulting in coating of the vacuum lines. In another exemplary process, the process may involve BCB and the temperature may be in the range of 350-400 C. In another exemplary process, the process may involve PBO and the temperature may be in the range of 200-250 C.

The vacuum lines run the risk of having vaporized liquids condensing along their interiors, resulting in coatings within these lines. This may result in the need to replace these lines periodically, which may present quite a maintenance burden upon operators of such process ovens. Some process ovens incorporate filters into the vacuum systems, which are adapted to screen out the droplets in the vapor. This approach may still result in significant condensation within vacuum lines in the system.

The risk having vaporized liquids condensing in inappropriate locations within a system is compounded with processes which result in even larger quantities of vaporized liquid being released. For example, with panel level wafer processing, there may be 300×300 mm or 600×600 mm panels which are processed. The larger surface areas may release significant amounts of vapor, which in turn may condense along exhaust lines, or in other inappropriate locations, which may then often require cleaning or replacement of system components.

Further, with Fan Out Wafer Level Processing (FOWLP), and with other applications, such as heterogeneous integration, individual die may be placed adjacent to each other and have molding compound around the die. The molding compound may be outgassed in conjunction with processing to remove the solvent from a polyimide precursor. Similar to the polymer vapor which may be liberated along with the solvent as the polyimide precursor is dried, the molding compound may in part vaporize and this molding compound vapor may travel with the chamber exhaust, further exposing the system to condensation in appropriate locations.

In some applications, the liberated compounds may be so voluminous that the vacuum pump may become blocked or otherwise have its operation impacted. Further, the larger volume of liberated compounds which may result from FOWLP and/or panel level wafer processing may present an environmental concern, such that it may be advisable, or required, to remove the material within the chamber exhaust. These applications may also utilize a solvent trap to process exhaust emission in a less environmentally concerning fashion.

What is called for is a system which minimizes condensation in process ovens, and their fixed vacuum lines, and which collects condensed vapors in such a manner that allows for easy maintenance.

### BRIEF DESCRIPTION OF THE DRAWINGS

FIGS. 1A and 1B are drawings of a process oven which may be used in conjunction with embodiments of the present invention.

FIG. 2 illustrates a trap assembly according to some embodiments of the present invention.

FIG. 3 is a drawing of a trap assembly according to some embodiments of the present invention.

FIG. 4 is a cutaway view of a trap assembly according to some embodiments of the present invention.

FIG. 5 is an illustration of a cutaway view of a trap assembly according to some embodiments of the present invention.

FIG. 6 is a colored view of a trap assembly on a bake oven according to some embodiments of the present invention.

FIG. 7 is a colored view of a trap assembly on a bake oven according to some embodiments of the present invention.

FIG. 8 is a colored cross-sectional view of a trap assembly on a bake oven according to some embodiments of the present invention.

FIG. 9 is a partial view of a process chamber with a polyimide trap according to some embodiments of the present invention.

FIG. 10 is view of a polymer trap assembly according to some embodiments of the present invention.

FIG. 11 is a cross-sectional view of a polymer trap assembly according to some embodiments of the present invention.

FIG. 12 is a cross-sectional view of a polymer trap assembly according to some embodiments of the present invention.

FIG. 13 is a top and cross-sectional view of a polymer trap assembly according to some embodiments of the present invention.

FIG. 14 is a side and cross-sectional view of a polymer trap assembly according to some embodiments of the present invention.

FIG. 15 is a cross-sectional view of a polymer trap assembly according to some embodiments of the present invention.

FIG. 16 is a top and cross-sectional view of a polymer trap assembly according to some embodiments of the present invention.

FIG. 17 is a side and cross-sectional view of a polymer trap assembly according to some embodiments of the present invention.

FIG. 18 is a cross-sectional view of a polymer trap assembly according to some embodiments of the present invention.

FIG. 19 is a flow deflector according to some embodiments of the present invention.

FIG. 20 is a flow deflector according to some embodiments of the present invention.

FIG. 21 presents views of a polymer trap assembly according to some embodiments of the present invention.

### SUMMARY

A trap system adapted to trap polyimide or other vapors exiting from a process chamber. The vapors are routed from the process chamber through a heated exit line at low pressure and then cooled, resulting in condensation at a selected location. The condensed vapors accumulate in a liquid trap. The trap assembly may include a flow deflector to increase flow alongside the heat sink portion of a cooling assembly. A method of condensing polymer vapors in vacuum exit lines of process chambers, where the flow which may have vaporized polymer vapor is cooled to enhance condensation at a chosen location.

### DETAILED DESCRIPTION

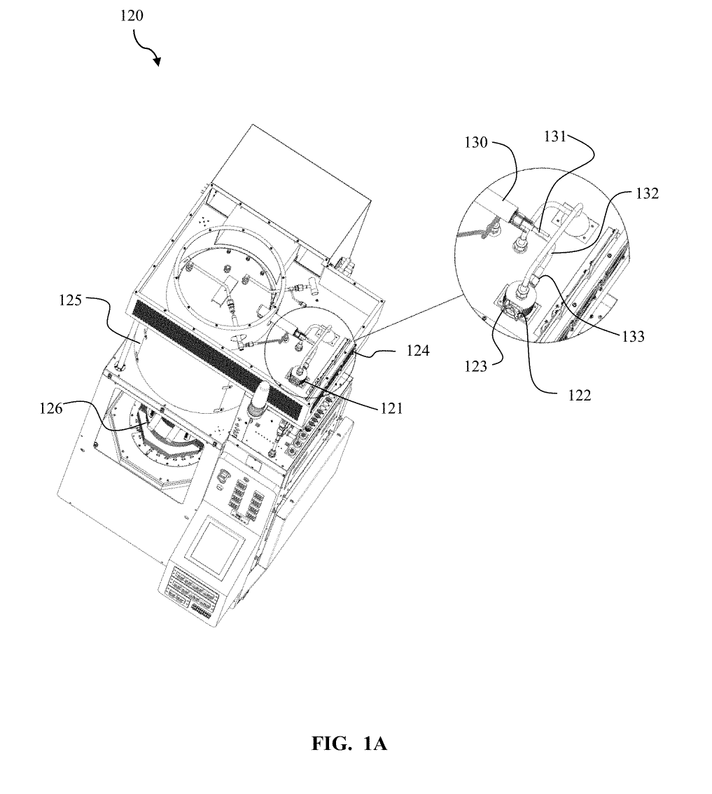

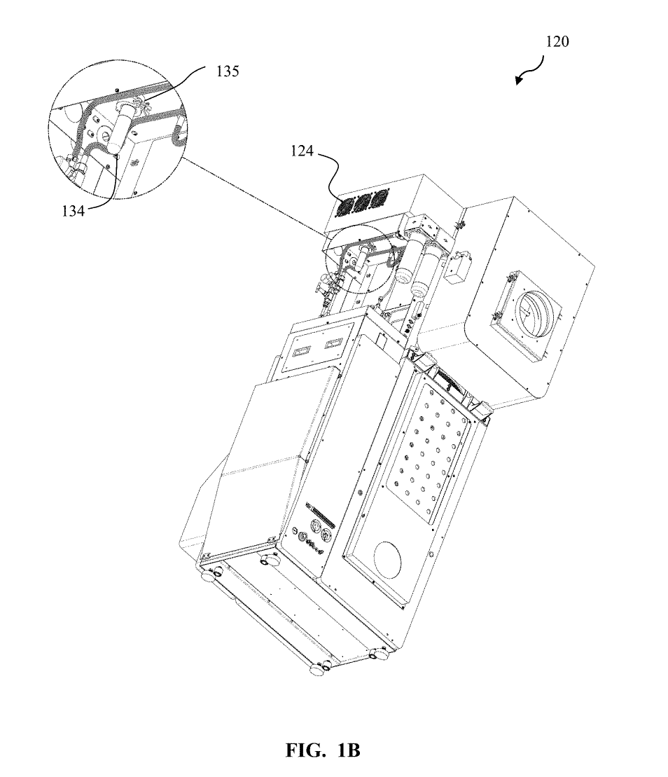

In some embodiments of the present invention, as seen in FIGS. 1A and 1B, a polyimide bake oven 120 is coupled to a polyimide trap assembly 121 and is used to cure polyimide layers. The use of the polyimide bake oven 120 may involve heating of the oven in support of temperature imidization of a polymer layer while under vacuum, for example. These processes may also include drying of a polyimide precursor layer prior to the temperature imidization. The baking of the substrate with the polymer layer may release solvents during the heating/baking of the layer. The solvents may carry along with them some vaporized polymer, which presents the risk that the vaporized polymer may condense in places not desired. For example, the vaporized polymer may condense in vacuum lines. The condensation within vacuum lines may decrease their functional capabilities as the cross-sectional flow area of the lines decrease with the polymer buildup along the interior walls of the lines. The build-up of condensate in the vacuum lines, or in other locations, may result in the need for frequent recurring maintenance in order to clean or replace components.

The polyimide bake oven 120 may include a main chamber 125 and a feeder assembly 126. The feeder assembly 126 may allow for the insertion into the polyimide bake oven 120 of stacks of horizontally laid wafers.

The polymer trap assembly 121 may include a trap assembly inlet 133 that is coupled to a vacuum exit line 132 from the main chamber 125. The vacuum exit line 132 may be heated with a heater 130 in order to minimize condensation within the line. A thermocouple 131 may be present on the vacuum exit line 132. With a heated process oven, and then a heated vacuum exit line 132, the amount of condensation within the process oven and the heated vacuum exit line 132 may be kept to a minimum. The vacuum exit line 132 may have a cross-sectional flow area of a first amount.

As the exhausting vapors travel further from the main chamber, they enter a polyimide trap assembly 121 which cools the flowing vapors, leading to condensation. The polymer trap assembly 121 is adapted to cause condensation of the polymer vapor flowing in the vacuum line in a specific location or region, so that the condensation does not occur in other portions of the system. Without such a system, it is expected that the exhaust piping will be impacted the further it is from the main chamber. As the exhausted vapor leaves the main chamber, it may remain as vapor at the exit temperature. Farther along a globular polyimide will form in the piping, and then farther along a coating will form. This will interfere with exhaust flow. With enough time the piping will become sufficiently, or completely, blocked which then requires removal and replacement of components. With the polymer, or polyimide, trap assembly the condensation may be so complete at the trap that no further downstream condensate forms, sparing the operator from costly and time consuming maintenance.

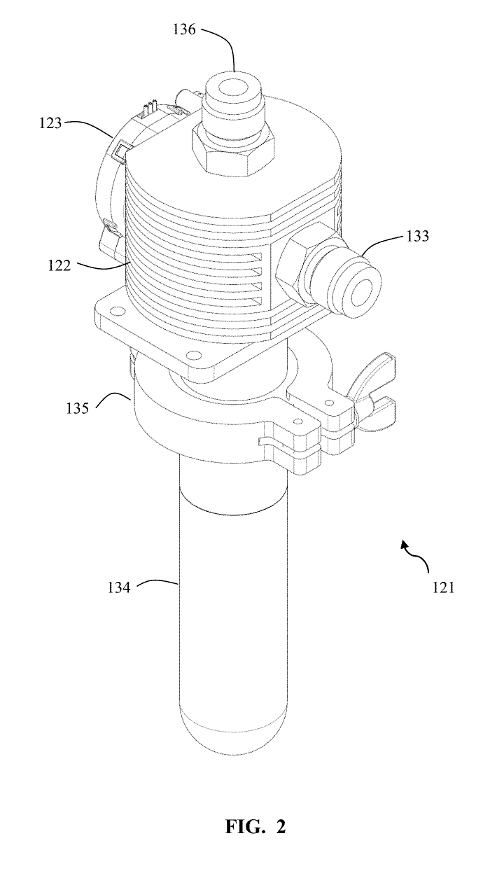

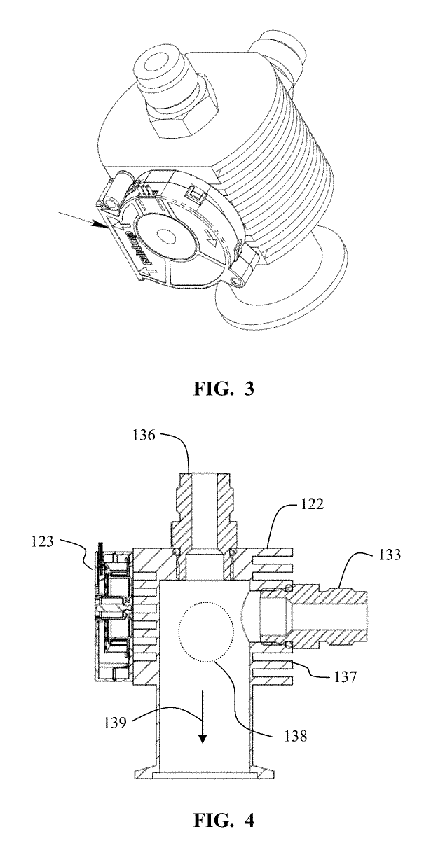

As also seen in FIGS. 2, 3, and 4, the trap inlet 133 routes the chamber exhaust into a condensing body 122. The condensing body 122 may be of aluminum and have fins 137 which allow for heat transfer from the hot chamber exhaust to the outside environment. A trap cooling blower 123 is coupled to the condensing body 122. As the exhaust passes into the interior space 138 of the condensing body 122 the exhaust is cooled, which allows for condensation of the vaporized polyimide into liquid which then flows 139 downward assisted by gravity. The condensing body may function as a cold sink which facilitates condensation along its interior surface as the chamber exhaust flows through the condensing body. Auxiliary fans 124, as seen in FIGS. 1A and 1B, may further provide air flow to recirculate the area around the condensing body. Also, the flow area through the condensing body is larger than the cross-sectional flow area of the vacuum exit line 132, which also will lead to condensation occurring in the condensation chamber portion of the condensing body. The exhaust travels out of the condensing body 122 through the trap outlet 136. The trap outlet 136 may be at the top of the condensing body 122. The condensed liquid flows downward into the vial 134, which is adapted to be removable. The vial 134 may be clear and may be of glass. A clamp assembly 135 may include a clamp and an O-ring seal.

In practice, the amount of liquid in the vial 134 may be observed by the operator. When the liquid is starting to fill the vial 134, the operator may remove and replace the vial with a new or emptied vial. With condensation of the polyimide now restricted to a chosen location and the condensed polyimide routed to the vial 134, replacement of the vial 134 may be the only process step needed to remove condensed polyimide. Further, other portions of the polyimide bake oven 120 and its exhaust and vacuum system are protected from condensation of polyimide, which previously required time consuming maintenance for its removal. The vacuum trap system is thus geared to control the location, or region, where condensation of polymer vapors is likely to occur.

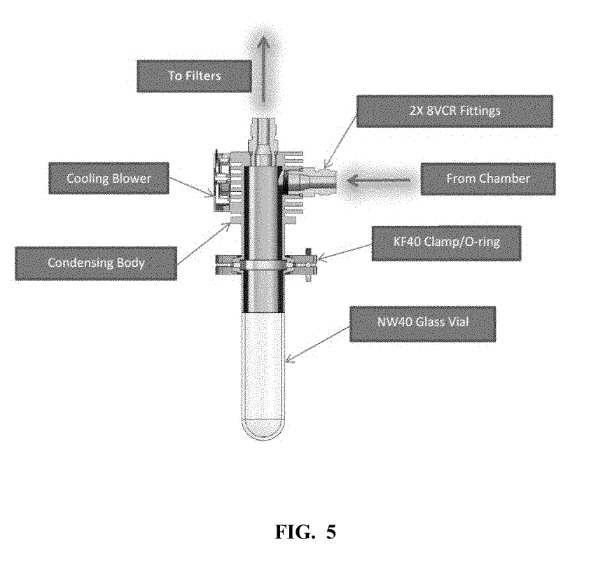

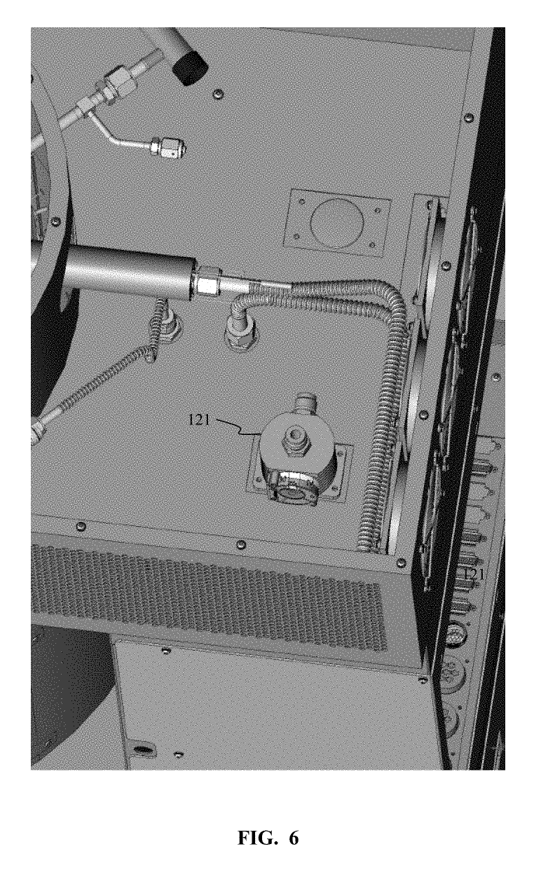

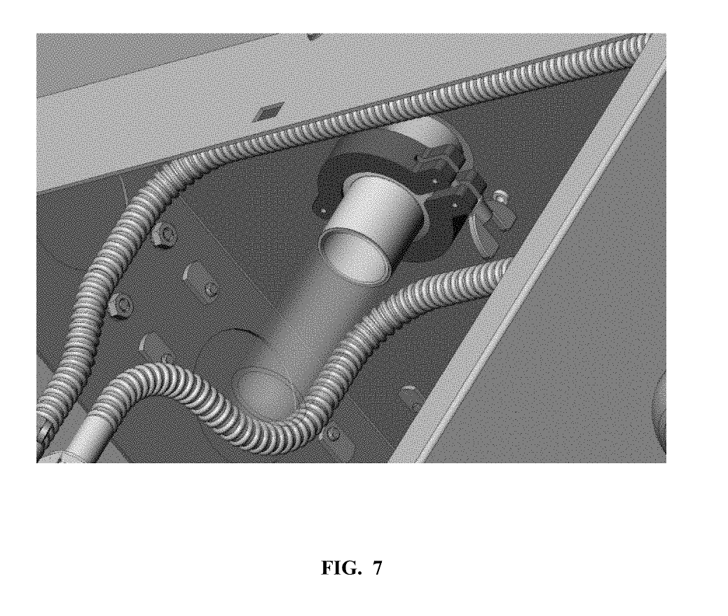

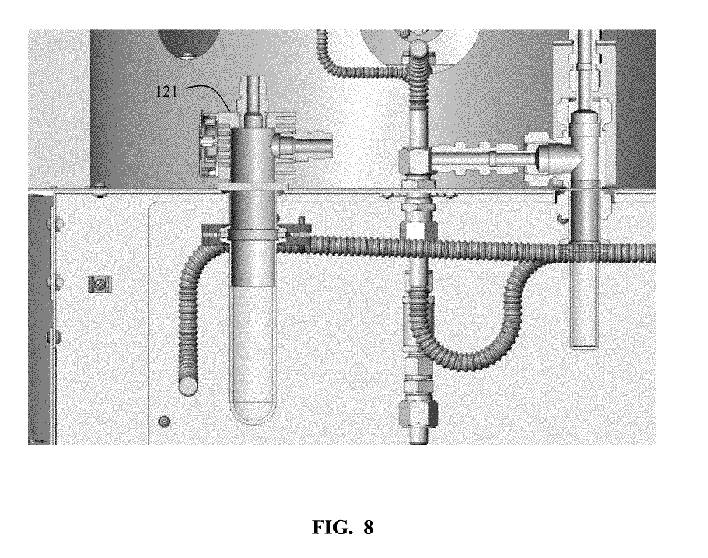

FIGS. 5 and 8 are cross-sectional views of a trap assembly according to some embodiments of the present invention. The polymer vapor may condense along the interior surfaces of the condensing body 122 and be pulled by gravity down into the vial 134. FIGS. 6 and 7 are illustrations of a bake oven with a trap assembly according to some embodiments of the present invention, which some components removed for ease of viewing. In addition to the trap cooling blower 123, the condensing body may be placed in the air flow path of one or more auxiliary fans 124.

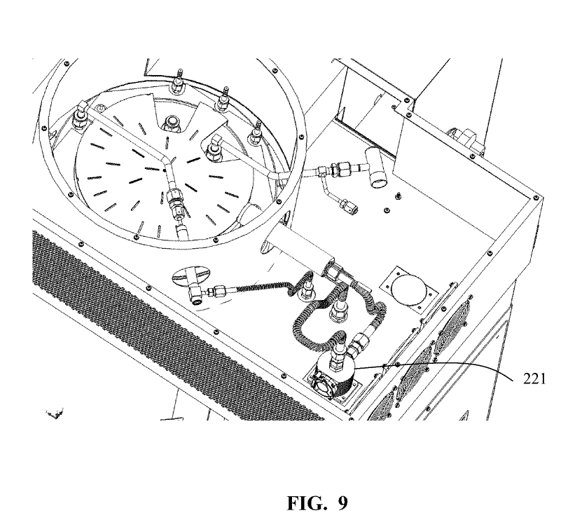

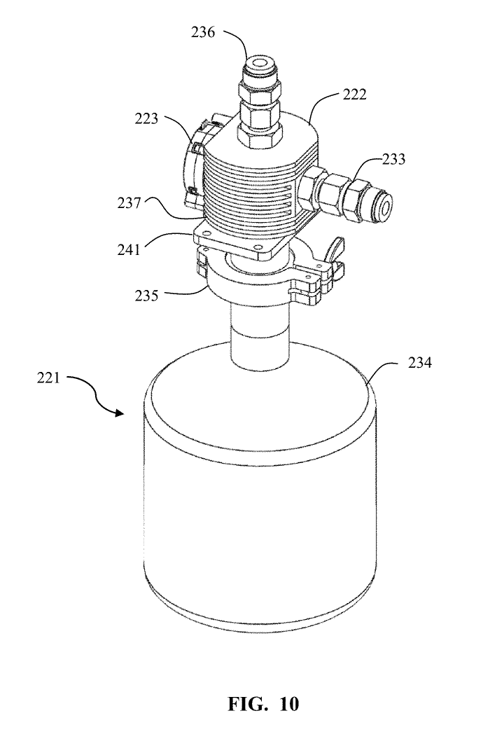

In some embodiments of the present invention, as seen in FIGS. 9-12, polyimide trap assembly 221 may include a flow deflector 240 which routes the flow of the chamber exhaust, which may include polymer vapor, along the interior surface of the condensing body. The polymer trap assembly 221 may include a trap assembly inlet 233 that is coupled to a vacuum exit line from the main chamber. The vacuum exit line may be heated with a heater in order to minimize condensation within the line. A thermocouple may be present on the vacuum exit line. The condensing body 222 may be of aluminum and have fins 237 which allow for heat transfer from the hot chamber exhaust to the outside environment. A trap cooling blower 223 is coupled to the condensing body 222. As the exhaust passes into the interior space of the condensing body 222 the exhaust is cooled, which allows for condensation of the vaporized polyimide into liquid which then flows downward assisted by gravity. The condensing body may function as a cold sink which facilitates condensation along its interior surface as the chamber exhaust flows through the condensing body. Auxiliary fans may further provide air flow to recirculate the area around the condensing body. Also, the flow area through the condensing body is larger than the cross-sectional flow area of the vacuum exit line 132, which also will lead to condensation occurring in the condensation chamber portion of the condensing body. The exhaust travels out of the condensing body 222 through the trap outlet 236. The trap outlet 236 may be at the top of the condensing body 222. The condensed liquid flows downward into the liquid container 234. The liquid container may be easily removable and replaceable and may be held with a clamp 235. The liquid container 234 is adapted to be removable.

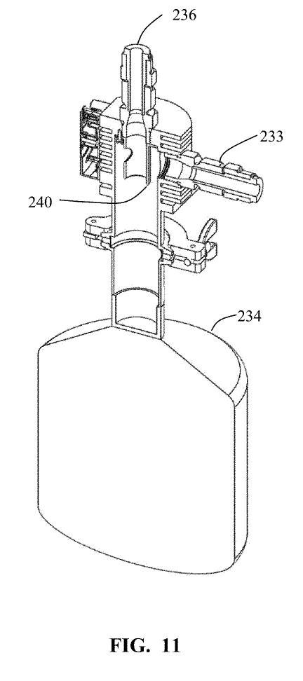

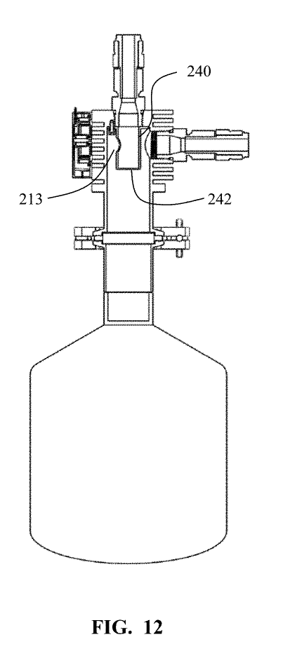

FIGS. 11 and 12 illustrate in cross-section aspects of the trap assembly 221. In this exemplary embodiment, the flow deflector 240 is fluidically coupled to the trap outlet 236. The flow deflector 240 is cylindrical in shape and resides within the cylindrical condensing chamber of the condensing body 222. The bottom of the flow deflector resides at an elevation lower than the inlet 233. The flow deflector 240 has an orifice 213 which allows entry of the exhaust flow into the flow deflector 240. The flow deflector 240 blocks the more direct path of the chamber exhaust from the inlet 233 up into the trap outlet 236, and instead directs the flow around exterior of the flow deflector, and around the adjacent interior surface of the condensation body. The interior surface of the condensation body is cooled with the trap cooling blower 223, and the longer flow path around the flow deflector will result in significantly more condensation in the trap assembly.

The bottom of the flow deflector 240 has an opening 242. The opening 242 allows for condensation which may form within the flow deflector to flow downward into the liquid container 234. This opening 242 may then allow for significantly longer operation of the trap assembly without the need for cleaning or replacement of the flow deflector.

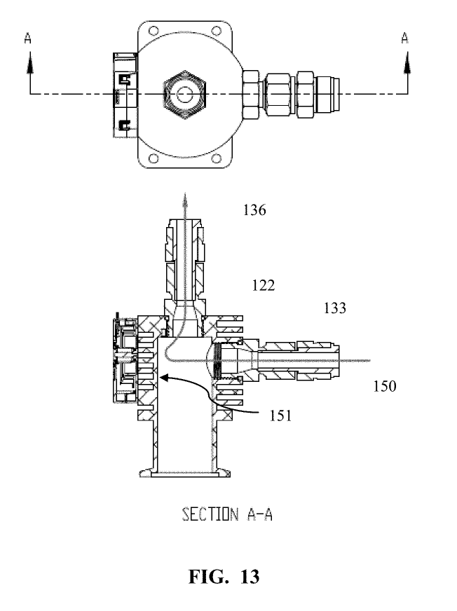

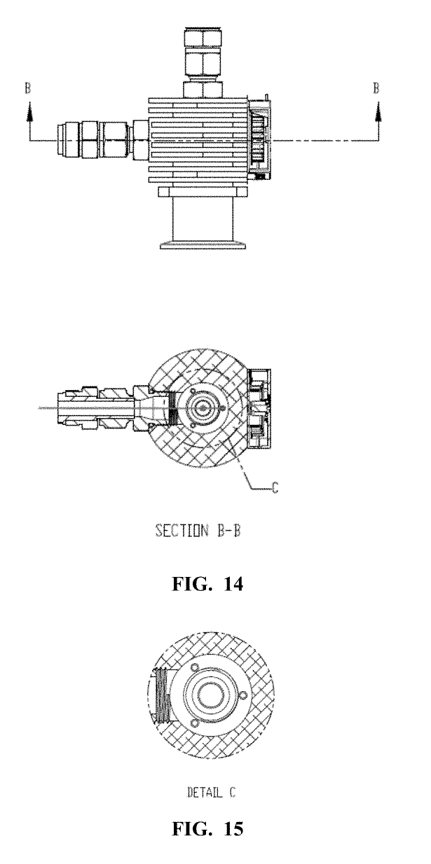

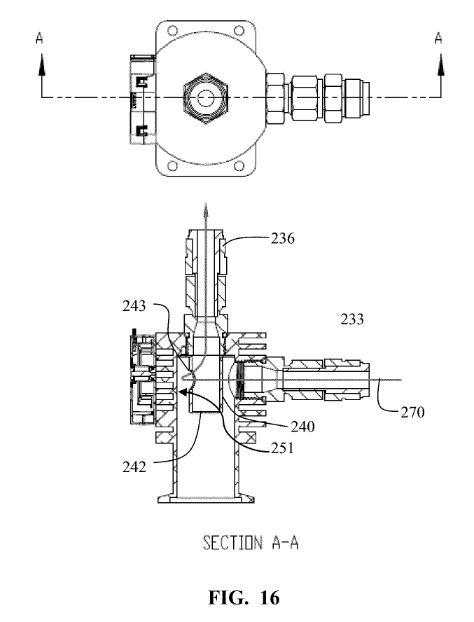

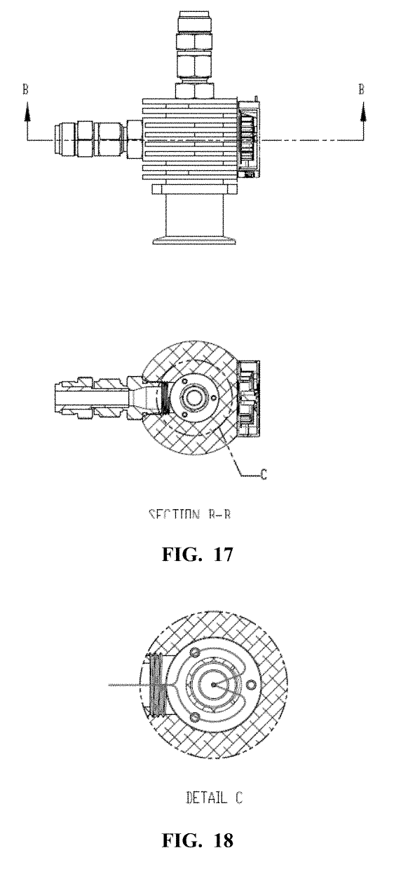

FIGS. 13-15 illustrate a first embodiment of the trap assembly 121, and FIGS. 16-18 illustrate a second embodiment of the trap assembly 221. Referring to the cross-sectional view of the first embodiment of the trap assembly 121 seen in FIG. 13, the chamber exhaust flow 150 enters the trap assembly via the trap inlet 133. The chamber exhaust flow may be routed to the trap inlet 133 via heated lines adapted to minimize or prevent condensation of vapors prior to their arrival at the trap assembly. The chamber exhaust flow 150 enters the condensation chamber within the condensing body 122. The inside surface 151 of the condensing body, which is also the outside perimeter of the condensation chamber, is cooled as described above. In this embodiment, the chamber exhaust flow 150 may enter the condensing body 122 and hit the cooled inside surface 151 as it routes up to the trap outlet 136. The cooled inside surface 151 leads to condensation of the vapors within the chamber exhaust flow along the inside surface 151. In addition, the expansion of the flow within the condensing body may lead to further condensation.

Referring to the cross-sectional view of the second embodiment of the trap assembly 221 seen in FIG. 16, the chamber exhaust flow 270 enters the trap assembly via the trap inlet 233. The chamber exhaust flow may be routed to the trap inlet 233 via heated lines adapted to minimize or prevent condensation of vapors prior to their arrival at the trap assembly. The chamber exhaust flow 270 enters the condensation chamber within the condensing body. The inside surface 251 of the condensing body, which is also the outside perimeter of the condensation chamber, is cooled as described above. In this embodiment, the chamber exhaust flow 270 may enter the condensing body 222 and is deflected around the flow deflector 240. The chamber exhaust flow 270 flows along the interior surface 251 as it routes around the flow deflector 240. The flow may then enter the orifice 243 into the center portion of the flow deflector and up to the trap outlet 236. The cooled inside surface 251 leads to condensation of the vapors within the chamber exhaust flow along the inside surface 251. In addition, the expansion of the flow within the condensing body may lead to further condensation. Condensation that forms inside of the flow deflector 240 may drip down through the opening 242 and into the fluid container.

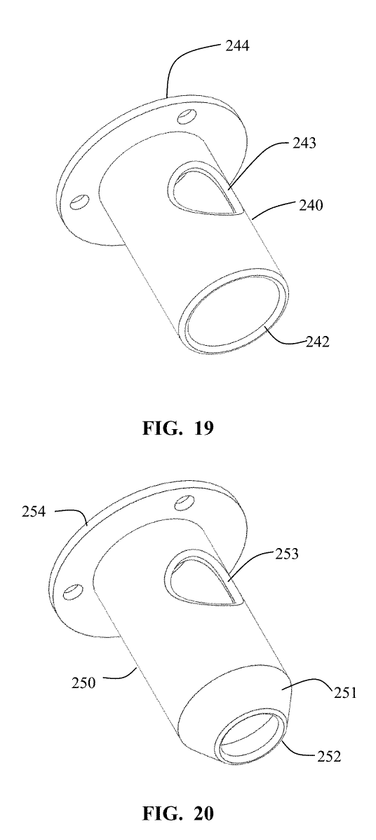

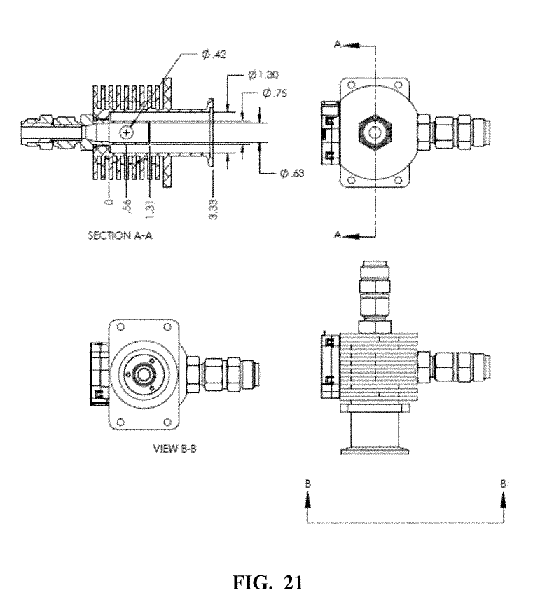

FIG. 19 illustrates a flow deflector 240 according to a first embodiment of the present invention. The flow deflector 240 is cylindrical and has a principal axis which is vertical. A mounting flange 244 allows for coupling to the condenser body. An orifice 243 is seen along the side of the flow deflector 240. An opening 242 is seen at the bottom of the cylindrical flow deflector 240.

FIG. 20 illustrates a flow deflector 250 according to a second embodiment of the present invention. The flow deflector 250 is cylindrical and has a principal axis which is vertical. A mounting flange 254 allows for coupling to the condenser body. An orifice 253 is seen along the side of the flow deflector 250. An opening 252 is seen at the bottom of the cylindrical flow deflector 250 below a narrowing portion 251. In some aspects, the flow deflector may be of a conical profile.

In some embodiments of the present invention, a drying process is carried out in a process chamber with low pressure/vacuum capabilities. The process chamber may also include capability for inletting heated inert gas, such as nitrogen. The process chamber may also be able to be heated for supporting the drying process. The process chamber may also be able to be heated to even higher temperatures to support temperature imidization processing after the drying portion of the process. The process chamber is coupled to a polyimide trap assembly as discussed above.

With reduced pressure, the solvent will boil at a lower temperature. For example, NMP boils at approximately 105 C at 50 Torr. Using an example of a substrate coated with a polyimide precursor, or a plurality of such coated substrates, the substrates are delivered into a process chamber. The process chamber may be heated to a temperature below the room temperature boiling point of the solvent. The solvent may be NMP and the initial heating temperature may be 150 C. The pressure used is subject to at least two conflicting constraints. On the one hand, the pressure should be reduced enough to evaporate the solvent, allowing for the low pressure liberation of the gas which permeates the liquid/gel precursor and is liberated to the low pressure chamber. On the other hand, too much evaporation, too quickly, could lead to aggregation of the gas into bubbles, which may lead to popping on the surface or other issues. Further, though, lowering the chamber pressure in further steps to a pressure even lower than 50 Torr creates more pressure differential between the bottom of the gel, against the substrate, and the low pressure chamber, better driving out the gas.

In an exemplary process according to some embodiments of the present invention, a polyimide precursor is applied to a silicon substrate. In some aspects, the polyimide precursor is applied directly over the silicon substrate. In some aspects, the polyimide precursor is applied over other layers already on a substrate, which may be other polyimide layers and metal layers, for example. In some aspects, the solvent used in the polyimide precursor is NMP. An expected thickness for semiconductor applications is in the range of 7-10 microns. Although a single substrate could be processed, in some aspects a plurality of substrates may be processed.

A process oven may be used to support a plurality of substrates within a chamber. The process oven may include internal heaters, heated inert gas inputs, and vacuum capability. In an exemplary embodiment, the substrates are placed into the chamber that has been heated to 150 C. In some aspects, the chamber is heated to a temperature in the range of 135 C to 180 C. The chamber pressure is reduced to a first drying pressure of 50 Torr. In some embodiments, the first drying pressure is in the range of 30-60 Torr. After reaching the first drying pressure, the chamber may then be flushed with a heated inert gas such as nitrogen at a pressure of 600 Torr. In some aspects the heated inert gas may be at a pressure in the range of 550 to 760 Torr. The nitrogen may be heated to the same temperature as the chamber, 150 C. The chamber pressure is then reduced to a second drying pressure of 25 Torr. In some embodiments, the second drying pressure is in the range of 15-30 Torr. After reaching the second drying pressure, the chamber may then be flushed with a heated inert gas such as nitrogen at a pressure of 600 Torr. In some aspects the heated inert gas may be at a pressure in the range of 550 to 760 Torr. The nitrogen may be heated to the same temperature as the chamber, 150 C. The chamber pressure is then reduced to a third drying temperature of 1 Torr. In some embodiments, the third drying pressure is in the range of 1-15 Torr. After reaching the third drying pressure, the chamber may then be filled with heated inert gas, such as nitrogen, up to 650 Torr, in preparation for imidization of the polyimide precursor. The substrates may then undergo temperature imidization in the same chamber. The subsequent temperature imidization may occur at 350-375 C, and as further described below. Each of these process steps may liberate process affluent laden with polyimide vapor, which may clog the vacuum exhaust system downstream from the process chamber.

In an exemplary embodiment further illustrating the timing of a process as described above, a process may begin with the heating of the process oven to a temperature of 150 C. A single substrate or a plurality of substrates within the process oven, which include a polyimide precursor including a solvent such as NMP, are put into the process oven which has been preheated to the temperature of 150 C. The process oven pressure is then reduced to a first drying pressure of 50 Torr. This portion of the process may take 2-3 minutes. The process oven is then flushed with preheated nitrogen heated to 150 C up to a pressure of 600 Torr. This portion of the process may take 2-3 minutes. The process oven pressure is then reduced to a second drying pressure of 25 Torr. This portion of the process may take 3-4 minutes. The process oven is then flushed with preheated nitrogen heated to 150 C up to a pressure of 600 Torr. This portion of the process may take 2-3 minutes. The process oven pressure is then reduced to a third drying pressure of 1 Torr. This portion of the process may take 4-5 minutes. The process oven is then flushed with preheated nitrogen heated to 150 C up to a pressure of 650 Torr. This portion of the process may take 2-3 minutes. The aforementioned steps have now greatly reduced the oxygen level in the process oven, as well as having removed all or nearly all of the solvent from the polyimide precursor with little or no bubbling or skinning of the polyimide precursor.

After the multi-step drying process, the substrates are now ready for temperature imidization. As discussed further below, the oxygen level in the process oven may now be down as low as approximately 1 ppm, as an end result of the drying process. An exemplary temperature imidization process may now include maintaining approximately 250 Torr in the process chamber while inputting heated nitrogen at the top of the process oven while pulling vacuum at the bottom of the process oven. The heated nitrogen and the oven temperatures may now be raised in unison, for example, to 350 C. At 4 C/minute, this heating process would take 50 minutes. At 350 C the oven and gas temperatures may be held for 1 hour for temperature imidization of the polyimide precursor. Although 350 C is an illustrative temperature using NMP, other temperatures may be used for the temperature imidization. During the temperature imidization process affluent laden with polyimide vapor may be liberated from the polyimide layers on the substrates. The process step of maintaining a pressure, such as 250 Torr, while curing the polyimide may result in a continuous flow of process affluent through the vacuum outlet. In prior applications, the vacuum outlet system and its piping were subject to clogging by the condensation of the polyimide in the system and piping. The use of the polyimide trap assembly as described above allows for the location of the polyimide condensation to be determined, and for the trapping of the polyimide condensation in a reservoir which his easily removable and replaceable. After the temperature imidization, the oven heaters may be turned off, which will result in a cooling of the oven. The heated nitrogen flow may be cooled at a rate which tracks the cooling oven.

In some aspects, the length of the vacuum exit line may be varied such that the flow through the line is cooled enough to allow for complete or near complete condensation in the condensation chamber. The length of the vacuum exit line may be selected such that the vacuum exit line is not subject to clogging condensation. The length of the vacuum exit line may be varied depending upon the temperature used in the oven, the polyimide type used in the oven during processing, and other factors. In one example, the temperature of the vacuum exit line at the entrance to the condensation body was approximately 65 C, the cooled condensation body temperature was approximately 30 C, and the condensation body exit line was approximately 44 C.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A polymer trap assembly, said polymer trap assembly comprising:
a trap assembly inlet;
a condensation body, said condensation body comprising:
an exterior; and
a condensation chamber, said condensation chamber fluidically coupled to said trap assembly inlet, said condensation chamber comprising an inner condensing surface;
a flow deflector, said flow deflector residing within said condensation chamber; and
a trap assembly outlet, said trap assembly outlet fluidically coupled to said condensation chamber.

2. The polymer trap assembly of claim 1 wherein said condensation body is a cooled condensation body, wherein said cooled condensation body comprises a heat exchanger adapted for heat exchange.

3. The polymer trap assembly of claim 2 wherein said heat exchanger comprises a plurality of fins adapted for heat exchange, said fins on an exterior surface of said condensation body.

4. The polymer trap assembly of claim 3 further comprising a cooling blower adapted to cool said heat exchanger.

5. The polymer trap assembly of claim 4 wherein said cooling blower is affixed to the exterior of said condenser body.

6. The polymer trap assembly of claim 1 further comprising:
a condensed fluid exit coupled to said condensation chamber; and
a removable and replaceable fluid reservoir coupled to said condensed fluid exit.

7. The polymer trap assembly of claim 2 further comprising:
a condensed fluid exit coupled to said condensation chamber; and
a removable and replaceable fluid reservoir coupled to said condensed fluid exit.

8. The polymer trap assembly of claim 5 further comprising:
a condensed fluid exit coupled to said condensation chamber; and
a removable and replaceable fluid reservoir coupled to said condensed fluid exit.

9. The polymer trap assembly of claim 1 wherein the vertical elevation of said trap assembly inlet is lower than the vertical elevation of said trap assembly outlet.

10. The polymer trap assembly of claim 8 wherein the vertical elevation of said trap assembly inlet is lower than the vertical elevation of said trap assembly outlet.

11. The polymer trap assembly of claim 10 wherein said fluid reservoir is a clear reservoir.

12. The polymer trap assembly of claim 1 wherein said flow deflector comprises a tube extending down from said trap assembly outlet, and wherein said trap assembly inlet is coupled to said condensation chamber along a side of said condensation chamber.

13. The polymer trap assembly of claim 12 wherein said tube comprises an orifice along a side of said tube.

14. The polymer trap assembly of claim 13 wherein said tube extends past said trap assembly inlet.

15. A bake oven assembly adapted for the drying and imidization of polymer, said bake oven assembly comprising:
a process chamber, said process chamber comprising a vacuum outlet;
a process chamber vacuum exit line fluidically coupled to said vacuum outlet of said process chamber; and
a polyimide trap assembly, said polyimide trap assembly comprising:
a trap assembly inlet;
a condensation body, said condensation body comprising:
an exterior; and
a condensation chamber, said condensation chamber fluidically coupled to said trap assembly inlet, said condensation chamber comprising an inner condensing surface;
a flow deflector, said flow deflector residing within said condensation chamber; and
a trap assembly outlet, said trap assembly outlet fluidically coupled to said condensation chamber.

16. The polymer trap assembly of claim 15 wherein said condensation body is a cooled condensation body, wherein said cooled condensation body comprises a heat exchanger adapted for heat exchange.

17. The polymer trap assembly of claim 16 wherein said flow deflector comprises a tube extending down from said trap assembly outlet, and wherein said trap assembly inlet is coupled to said condensation chamber along a side of said condensation chamber.

18. The polymer trap assembly of claim 17 wherein said tube comprises an orifice along a side of said tube.

19. The polymer trap assembly of claim 18 wherein said tube extends past said trap assembly inlet.
